(19) United States
(12) Patent Application Publication
(10) Pub. No.: US 2006/0157963 A1
(43) Pub. Date: Jul. 20, 2006

(54) Gas bag for a vehicle occupant restraint device

(75) Inventor: Michael Deckenhoff, Duelmen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/319,327

(22) Filed: Dec. 28, 2005

(30) Foreign Application Priority Data
Jan. 19, 2005 (DE) 20 2005 000 818.4

(51) Int. Cl. B60R 21/23; B60R 21/01

(52) U.S. Cl. 280/743.1; 280/735

(57) ABSTRACT

A gas bag (10) for a vehicle occupant restraint device has a gas bag wall formed from at least one fabric piece (12). The gas bag (10) further has an electrically controllable device (14) which is arranged at the gas bag wall. The gas bag (10) further comprises an electric conductor (16). The fabric piece (12) and the electric conductor (16) form a pre-assembled unit.

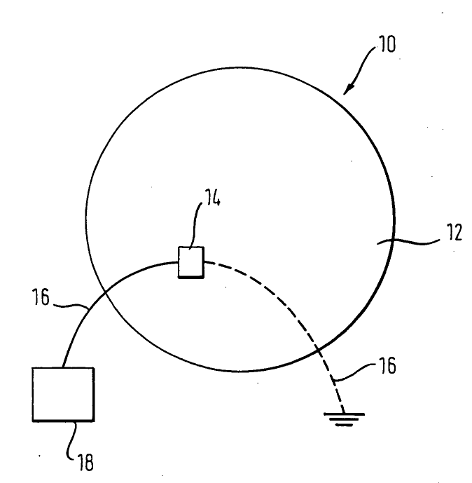

### TECHNICAL FIELD

The invention relates to a gas bag for a vehicle occupant restraint device. The invention further relates to a gas bag module having such a gas bag.

### BACKGROUND OF THE INVENTION

Gas bags are known in which, under certain circumstances, discharge openings in the gas bag fabric can be opened by active devices at a defined moment. GB-A-2 306 409 shows a gas bag having a gas bag wall formed from at least one fabric piece and having an electrically controllable device arranged on the gas bag wall. The gas bag is provided with a pyrotechnic charge. The pyrotechnic charge can be ignited by an electric lead, in order to provide a discharge opening for the gas which is in the gas bag.

The construction of a gas bag module with such a gas bag is, however, made difficult in that the electric lead for the electrically controllable device, which is arranged at the gas bag wall, has to be housed in the module in a suitable manner. In addition, care is to be taken that the electric lead is not damaged upon unfolding of the gasbag and, vice versa, that it does not impede the unfolding of the gas bag.

It is an object of the invention to provide a gas bag having an electrically controllable device, in which the mounting of the gas bag module is simplified with respect to the above-mentioned criteria.

### BRIEF SUMMARY OF THE INVENTION

According to the invention, a gas bag for a vehicle occupant restraint device has a gas bag wall formed from at least one fabric piece. The gas bag also has an electrically controllable device arranged on the gas bag wall. The gas bag further comprises an electric conductor. The fabric piece and the electric conductor form a pre-assembled unit. The gas bag according to the invention has the advantage that no errors in mounting can occur when the electric lead for the electrically controllable device is accommodated, because the positioning of the electric lead has already been completed before the final assembly of the gas bag module. Thereby, it is ensured that the electric conductor is fixed on the fabric piece in the desired manner, so that a reliable, reproducible connection of the electric device is brought about.

The electric conductor is preferably integrated into the fabric piece, i.e. the electric conductor can not be readily removed from the fabric piece.

In particular, the electric conductor may be woven into the fabric piece, glued onto the fabric piece or sewn into the fabric piece. The electric conductor may be arranged on the exterior or on the interior of the gas bag or between two or more fabric layers.

In order to rule out breakdowns, the electric conductor may be at least partially surrounded by an insulating arrangement, in particular in the form of a coating or a sheath.

The invention also provides a gas bag module having a gas bag according to the invention, in which the electric conductor on the one hand is connected directly or indirectly with a control apparatus and on the other hand directly or indirectly with the electric device. In this case, the electric conductor is used to control the electric device.

According to another aspect, the invention provides a gas bag module having a gas bag according to the invention, in which the electric conductor represents a grounding for the electrically controllable device.

### BRIEF DESCRIPTION OF THE DRAWINGS

In the drawing, the single Figure shows diagrammatically a gas bag according to the invention.

### DETAILED DESCRIPTION OF THE PREFERRED EMBODIMENTS

In the Figure, an inflated gas bag 10 is illustrated, having a gas bag wall which is formed from one or more fabric pieces 12. An electric device 14 is arranged on the gas bag wall. The device is electrically controllable and serves to provide a discharge opening in the gas bag wall if required.

For this purpose, the electric device 14 is connected via an electric lead 16 to a control device 18 which brings about the activation of the electric device 14. The electric conductor 16 may be integrated into the fabric piece 12 in various ways, as described in the introductory section of the description, and may possibly be surrounded by an insulator.

The electric conductor 16, together with the fabric piece 12, forms a preassembled unit for the assembly of a gas bag module which is equipped with the gas bag 10.

According to another aspect of the invention, the electric conductor 16 may also serve to ground the electric device 14.

1. A gas bag for a vehicle occupant restraint device, the gas bag having a gas bag wall formed from at least one fabric piece, and an electrically controllable device arranged on the gas bag wall, the gas bag further comprising an electric conductor, the fabric piece and the electric conductor forming a pre-assembled unit.

2. The gas bag according to claim 1, wherein the electric conductor is integrated into the fabric piece.

3. The gas bag according to claim 2, wherein the electric conductor is woven into the fabric piece.

4. The gas bag according to claim 2, wherein the electric conductor is glued into the fabric piece.

5. The gas bag according to claim 2, wherein the electric conductor is sewn into the fabric piece.

6. The gas bag according to claim 2, wherein the electric conductor is arranged between two or more fabric layers.

7. The gas bag according to claim 1, wherein the electric conductor is surrounded at least partially by an insulating arrangement.

8. A gas bag module having a gas bag, the gas bag having a gas bag wall formed from at least one fabric piece, and an electrically controllable device arranged on the gas bag wall, the gas bag further comprising an electric conductor, the fabric piece and the electric conductor forming a pre-assembled unit, wherein the electric conductor being connected on the one hand directly or indirectly with a control apparatus and on the other hand directly or indirectly with the electric device.

9. A gas bag module having a gas bag, the gas bag having a gas bag wall formed from at least one fabric piece, and an electrically controllable device arranged on the gas bag wall, the gas bag further comprising an electric conductor, the fabric piece and the electric conductor forming a pre-assembled unit, wherein the electric conductor representing a grounding for the electrically controllable device.
